(19) United States
(12) Patent Application Publication
(10) Pub. No.: US 2024/0395528 A1
(43) Pub. Date: Nov. 28, 2024

(54) Deflector Gates for Ion Beam Intensity Modulation

(71) Applicant: DH Technologies Development Pte. Ltd., Singapore (SG)

(72) Inventors: Robert HAUFLER, Toronto (CA); William LOYD, Sugar Land, TX (US)

(21) Appl. No.: 18/693,363

(22) PCT Filed: Sep. 28, 2022
(86) PCT No.: PCT/IB2022/059261

§ 371 Date: Mar. 19, 2024

Related U.S. Application Data
(60) Provisional application No. 63/249,944, filed on Sep. 29, 2021.

(51) Int. Cl. H01J 49/06; H01J 49/02

(52) U.S. Cl. CPC H01J 49/061; H01J 49/022

(57) ABSTRACT

In one aspect, a mass spectrometer is disclosed, which includes an ion path along which an ion beam can propagate, and an ion beam deflector positioned in the ion path and configured to modulate transfer of an ion beam received from an upstream section of the ion path to a downstream section thereof, said ion beam deflector comprising at least one electrically conductive electrode positioned relative to one another to provide an opening through which the ion beam can pass, where the two electrodes are electrically insulated relative to one another so as to allow maintaining each electrode at a DC potential independent of a DC potential at which the other electrode is maintained.

### RELATED APPLICATION

The present application claims priority to provisional application number U.S. 63/249,944 filed on Sep. 29, 2021, which is herein incorporated by reference in its entirety.

### TECHNICAL FIELD

The present disclosure in general relates to mass spectrometry and in particular to systems and methods for modulating the intensity of an ion beam employed in a mass spectrometer.

### BACKGROUND

The present teachings are generally related to systems and methods for modulating an ion beam intensity in a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

In many mass spectrometers, there is a need for modulating the intensity of an ion beam, generated via ionization of a sample, as the ion beam propagates through the mass spectrometer.

### SUMMARY

In one aspect, a mass spectrometer is disclosed, which includes an ion path along which an ion beam can propagate, and an ion beam deflector positioned in the ion path and configured to modulate transfer of an ion beam received from an upstream section of the ion path to a downstream section thereof, said ion beam deflector comprising at least two electrically conductive electrodes positioned relative to one another to provide an opening through which the ion beam can pass, where the two electrodes are electrically insulated relative to one another so as to allow maintaining each electrode at a DC potential independent of a DC potential at which the other electrode is maintained.

In some embodiments, the ion deflector can be implemented as a plurality of conductive electrodes that are positioned relative to one another to allow deflecting an ion beam with a given charge polarity along one of at least two possible directions. A controller can be operably coupled to at least one voltage source that supplies voltages to the conductive electrodes of the ion deflector so as to adjust the pattern of voltages applied to those electrodes, e.g., the polarity of the voltages applied to those electrodes, so as to adjust the direction along which the ion beam is deflected. By way of example, as discussed in more detail below, in some embodiments, the ion deflector can include four conductive electrodes that are shaped and positioned relative to one another to provide two intersecting slits through which ions can pass. By adjusting the voltages (e.g., the polarity of the voltages) applied to the conductive electrodes, an ion beam of a given charge polarity can be deflected along two directions one which is within one of the slits and the other is within the other slit.

At least one DC voltage source is operably coupled to the two conductive electrodes for application of DC voltages thereto. The mass spectrometer further includes a controller in communication with said at least one DC voltage source for modulating DC voltages applied to said two electrically conductive electrodes so as to transition the DC potential difference across the two electrodes between a first level at which the ion beam passes substantially undeflected through said ion deflector and a second level at which the ion beam is deflected from said ion path.

By way of example, the two electrically conductive electrodes can be two conductive plates that are separated by a gap through which the ion beam can pass. The application of a DC voltage differential across the plates can generate an electric field that can cause the deflection of the ion beam passing through the gap. In other embodiments, the electrically conductive electrodes can be in the form of two rods that are separated from one another to allow the passage of an ion beam therebetween. A voltage differential applied across the two rods can be modulated so as to steer an ion beam passing between the rods along a direction of interest. In yet other embodiments, the electrically conductive electrodes can be in the form of two conductive plates that are separated from one another to provide a passageway through which can an ion beam can pass. A voltage differential applied across the plates can be adjusted to affect the propagation path of the ion beam, e.g., by deflecting the ion beam toward one of the electrodes.

In some embodiments, at least one beam-collecting electrode can be disposed downstream of the ion beam deflector for collecting the deflected ion beam.

In some embodiments, the mass spectrometer can include at least one evacuated chamber in which at least a portion of the ion path is disposed. For example, the mass spectrometer can include two evacuated chambers that are in fluid communication and are differentially pumped to be maintained at different pressures. In such embodiments, the ion deflector can be positioned between the two chambers to allow modulating the intensity of the ion beam travelling between those two chambers.

The ion beam deflector can be positioned between the two evacuated chambers. In some such embodiments, an ion lens can be positioned upstream of the ion deflector. In such embodiments, the DC voltage source can be configured to apply a voltage difference between the upstream ion lens and the ion deflector so as to generate an electric field therebetween for deflecting the ion beam as it passes through the ion deflector.

The mass spectrometer can further include a controller that is configured to control the voltage source to adjust the voltages applied to the conductive electrodes of the ion deflector so as to modulate the transmission of the ion beam through the ion deflector. By way of example, the controller can cause the voltage source to apply substantially similar voltages or different voltages to the two conductive electrodes of the ion deflector so as to allow the ion beam to pass substantially undeflected through the ion beam deflector or to cause the deflection of the ion beam as it passes through the ion deflector, respectively. In some embodiments, the conductive electrodes can be formed of a suitable metal, such as, stainless steel, copper, copper alloys, gold-plated ceramics, and gold-plated PCB, and molybdenum alloys.

By way of example, the controller can cause the voltage source to apply a voltage differential across the two electrodes of the ion deflector so as to deflect the ion beam by a deflection angle, e.g., a deflection angle in a range of about 5 to about 60 degrees, though other deflection angles can also be utilized. In some embodiments, the controller can control the voltage source such that it applies a voltage differential across the two electrodes so as to substantially inhibit the passage of the ion beam from one evacuated chamber to another evacuated chamber between which the ion deflector is positioned.

In some embodiments, the ion beam deflector can be in the form of an ion lens having an opening through which ions can pass. In some such embodiments, the ion lens can be formed as two electrically conductive electrodes (e.g., two semi-circular electrodes) that are insulated from one another and separated so as to provide at least one opening for passage of the ion beam therethrough. By way of example, the two conductive electrodes can be separated by a slit through which the ion beam can pass.

In some embodiments, the first chamber can be maintained at a pressure in a range of about 0.1 Torr to about 10 Torr and the second chamber can be maintained at a pressure in a range of about 0.001 Torr to about 0.1 Torr.

In some embodiments, a set of rods arranged in a multipole configuration providing a passageway through which ions can pass, may be disposed in any of the evacuated chambers. In some embodiments, DC and/or RF voltages can be applied to the multipole rods, e.g., via one or more DC and/or RF voltage sources, such that the rod set functions as an ion guide and/or a mass analyzer.

In some embodiments, a controller can control the DC voltages applied to the conductive electrodes of an ion deflector according to the present teachings so as to steer an ion beam in a direction of interest. For example, the controller can cause a switching of the polarities of the voltages applied to two conductive electrodes separated from one another to provide a slit through which ions pass in order to change the direction along which the ions are deflected. By way of example, in some embodiments, an ion deflector according to the present teachings can include four conductive electrodes, e.g., four wedge-shaped conductive electrodes, that are positioned relative to one another so as to provide intersecting slits. By adjusting voltages applied to the conductive electrodes, an ion beam can be steered along different directions, e.g., right, left, up or down.

In a related aspect, a mass spectrometer is disclosed, which comprises an ion path along which an ion beam can propagate, an ion beam deflector positioned in said ion path and configured to modulate transfer of an ion beam received from an upstream section of the ion path to a downstream section thereof, said ion beam deflector comprising at least one electrically conductive electrode, at least one DC voltage source operably coupled to said at least one electrically conductive electrode for application of DC voltages thereto, and a controller in communication with said at least one DC voltage source for modulating DC voltages applied to said at least one electrically conductive electrode so as to transition the DC voltage applied to said at least one electrode between a first level at which the ion beam passes substantially undeflected through said ion deflector and a second level at which the ion beam is deflected from said ion path. In some embodiments, the at least one electrically conductive electrode includes a single electrode positioned either above or below the ion path. In some embodiments, the DC voltage at the second level is configured to cause a deflection of the ion beam relative to the ion path at an angle in a range of about 5 to about 60 degrees.

In some embodiments, an ion lens is positioned upstream of the ion beam deflector and the controller is configured to cause said at least one DC voltage source to adjust a DC voltage applied to said at least one electrically conductive electrode between a first level at which the at least one electrically conductive electrode and the ion lens are maintained at the same electric potential to allow the ion beam to pass undeflected through the ion beam deflector and a second level at which the at least one electrically conductive electrode and the ion lens are maintained at different electric potentials to cause the ion beam to deflect as the ion beam passes through the ion beam deflector.

In one aspect, a method for modulating intensity of an ion beam propagating along an ion path is disclosed, which includes passing the ion beam relative to an electrically conductive electrode to which a DC voltage is applied and modulating the applied DC voltage, e.g., at a duty cycle in a range of about 0.001 to about 1, between a first level at which the ion beam continued propagating substantially undeflected along its propagation path and a second level at which the ion beam is deflected from its propagation path.

In a related aspect, a method for modulating intensity of an ion beam propagating along an ion path is disclosed, which includes passing the ion beam between two electrodes insulated from one another to allow sustaining a DC potential difference therebetween, and modulating the DC potential difference across the two electrodes between at least a first level and a second level such that when the DC potential difference is at said first level the ion beam continues propagating substantially undeflected along its path and when the DC potential difference is at said second level the ion beam is deflected from its propagation path.

In some embodiments of the above method, the DC voltage differential applied across the electrodes of the ion deflector can be modulated at a duty cycle, e.g., in a range of about 0.001 to about 1.

Further understanding of various aspects of the present teachings can be obtained by reference to the following detailed description in conjunction with the associated drawings, which are described briefly below.

### BRIEF DESCRIPTION OF THE DRAWINGS

FIGS. 1A and 1B show a conventional ion-deflection system that can be employed in a mass spectrometer, where the ion-deflection system includes two ion lenses that are axially separated and to which a voltage differential can be applied to cause the deflection of the ion beam as it passes through the ion lenses,

FIG. 2 is a graph depicting that ions pass through the ion-deflection system shown in FIGS. 1 and 2 when the voltage differential between the two lenses is zero and are inhibited from passing through the ion-deflection system upon application of a voltage differential between the two ion lenses,

FIGS. 3A and 3B schematically depict an ion deflector assembly according to an embodiment of the present teachings that is positioned between two evacuated chambers of a mass spectrometer,

FIGS. 4A and 4B schematically depict an ion deflector according to an embodiment of the present teachings for use in a mass spectrometer, where FIG. 4A shows the ion deflector assembly in a state in which ions can pass through the deflector substantially undeflected and FIG. 4B shows the ion deflector assembly in a state in which the ions are inhibited from passing through the ion deflector,

FIG. 4C is a top schematic view of an ion deflector having two electrically conductive electrodes that are electrically insulated from one another,

FIG. 5A is a partial view of an ion deflector according to an embodiment (only one of the conductive electrodes is shown in the figure),

FIG. 5B schematically depicts voltage differential applied to the ion deflector depicted in FIGS. 4A and 4B as a function of time, illustrating modulation of the ion beam by the ion deflector,

FIG. 6A schematically depicts a mass spectrometer according to an embodiment of the present teachings in which an ion deflector according to an embodiment of the present teachings is incorporated,

FIG. 6B schematically depicts an ion deflector according to an embodiment, which is positioned between two ion guides, where each ion guide is positioned in an evacuated chamber of a mass spectrometer,

FIG. 6C schematically depicts an embodiment of an ion deflector according to the present teachings, which includes two plates located above and below the ion beam passing on the centerline between the two plates,

FIG. 6D schematically depicts an ion deflector according to an embodiment of the present teachings for steering the path of an ion beam,

FIG. 6E schematically depicts an ion deflector according to another embodiment of the present teachings,

FIG. 7 schematically depicts an example of an implementation of a controller according to an embodiment of the present teachings,

FIG. 8 schematically depicts an example of an implementation of a controller suitable for use in various embodiments of the present teachings,

FIG. 9A schematically depicts a single electrode that can be utilized in some embodiments of the present teachings for deflecting an ion beam,

FIG. 9B is a schematic side view of the electrode depicted in FIG. 9A and further illustrating the deflection of an ion beam via the electrode when an appropriate DC bias voltage is applied to the electrode,

FIG. 9C schematically depicts a single electrically conductive electrode in the form of a bar that can be employed in some embodiments of the present teachings for deflecting an ion beam, and

FIG. 9D schematically depicts a wire that can be employed as an electrically conductive electrode in some embodiments for deflecting an ion beam.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

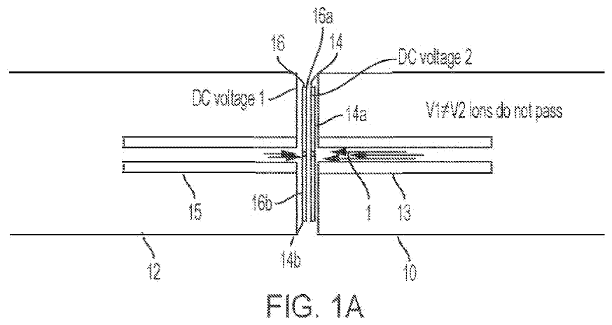

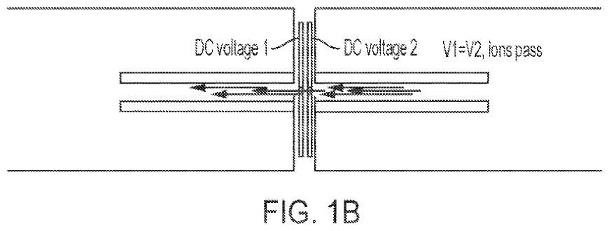

With reference in FIGS. 1A and 1B, in a conventional mass spectrometer, the intensity of an ion beam 1 passing between two differentially pumped chambers 10 and 12 that are maintained at different pressures and in which two devices 13 and 15, e.g., two ion guides, are disposed can be modulated using two ion lenses 14 and 16 that are axially separated from one another and include openings through which the ion beam can pass. The ion lens 14 includes an upstream surface 14a and a downstream surface 14b and the ion lens 16 includes an upstream surface 16a and a downstream surface 16b.

As shown in FIG. 1B, the application of the same DC voltages to the ion lenses 14 and 16 allows the ion beam to pass through the lenses without a change in its propagation direction. Typically, the ion lenses are maintained at a DC potential that facilitates the passage of the ion beam from the chamber 10 into chamber 12, e.g., via a voltage offset relative to any of the upstream and/or downstream multipole rods.

In order to stop the passage of the ion beam from chamber 10 into chamber 12, a differential voltage can be applied across the two ion lenses 14 and 16, as shown in FIG. 1, to slow down the ions as they pass between the two lenses and cause a reversal in their propagation direction such that they will impinge on the downstream surface 16b of the lens 16. The impingement of the ions on the downstream surface 16b of the lens 16 may cause contamination of that lens surface, which can in turn cause a degradation in the performance of a mass spectrometer in which the two chambers and the ion lenses are incorporated.

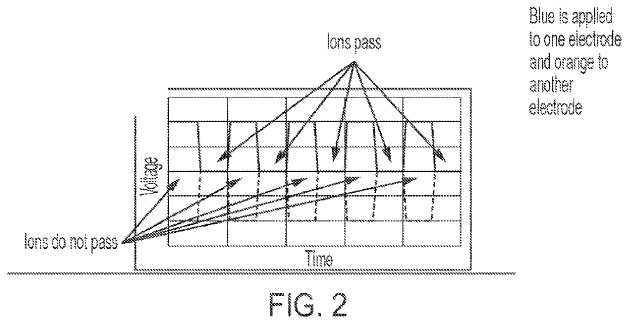

By modulating the voltage differential applied between the two ion lenses, the passage of the ion beam between the two chambers 10 and 12 can be modulated. By way of illustration, FIG. 2 shows a hypothetical example in which the transfer of an ion beam between the two chambers is periodically modulated via a periodic change in the voltage differential applied between the two ion lenses. The solid trace depicts the voltage applied to one conductive electrode of the ion deflector and the dashed trace depicts the voltage applied to the other conductive electrode of the ion deflector. In particular, this example shows that the ion beam passes from chamber 10 into chamber 12 when the voltage differential between the two ion lenses is zero and its passage between the two chambers can be inhibited from passage from chamber 10 into chamber 12 via application of a non-vanishing voltage differential between the two ion lenses.

As discussed in more detail below, in embodiments, rather than causing reversal and impingement of an ion beam on a lens surface, a plurality of conductive electrodes (herein also referred to as ion deflection electrodes) can be employed such that the ion beam can be deflected, via application of appropriate voltages to those electrodes, as the ion beam passes through a gap provided between the two electrodes.

In some embodiments, the deflection angle of the ion beam is such that the ion beam is inhibited from entering the second chamber. By modulating a voltage differential applied between the deflection electrodes, the passage of the ion beam from the first chamber to the second chamber can be controlled. As discussed further below, the ion deflection electrodes may have different shapes and configurations. By way of example, in some embodiments, the ion deflection electrodes can be in the form of two plates that are separated from one another by a gap through which the ion beam can pass. In other embodiments, the conductive electrodes can be in the form of two portions of an ion lens that are insulated relative to one another and include an opening therebetween through which the ion beam can pass. Other suitable shapes and/or arrangements of the conductive electrodes can also be employed.

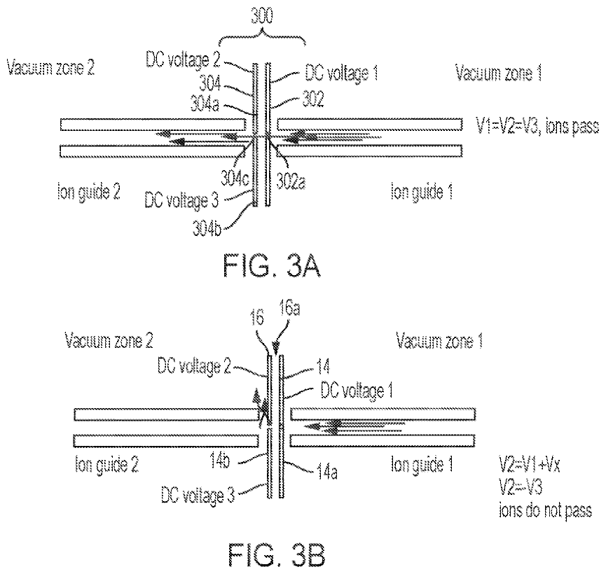

FIGS. 3A and 3B schematically depict an ion deflector assembly 300 according to an embodiment, which is positioned between two ion guides 1 and 2, where the ion guide 1 is disposed in vacuum zone 1 (e.g., within one evacuated chamber) and the ion guide 2 is disposed in a vacuum zone 2 (e.g., within another evacuated chamber). The vacuum zones 1 and 2 are differentially pumped so as to be maintained at different pressures.

The ion deflector assembly 300 includes an ion lens 302 having an opening 302a through which ions can pass and an ion deflector 304 according to an embodiment of the present teachings, which is disposed downstream of the ion lens 302. In this embodiment, the ion deflector 304 includes two semi-circular conductive electrodes 304a/304b that are separated from one another to form a slit 304c therebetween through which ions can pass. Further, the semi-circular portions are electrically insulated from one another to allow the application of independent voltages to the conductive portions so as to modulate the electric field within the slit, thereby affecting the propagation path of the ions passing through the slit. For example, as shown in FIG. 3A, when the ion lens 302 and the two conductive electrodes 304a/304b are maintained at the same voltage, the ions pass through the ion deflector 304 without being deflected and reach the downstream ion guide 2.

In contrast, FIG. 3B shows an example of voltages that can be applied to the ion lens 302 and the conductive electrodes of the ion deflector 304 to cause the ion beam received by the ion deflector via the ion guide 1 to be deflected away from the inlet of the ion guide 2, thereby inhibiting the passage of the ions from the ion guide 1 into the ion guide 2. In this example, the DC voltages 1 and 2 have the same polarity but different magnitudes while the DC voltages 2 and 3 have the same magnitudes but opposite polarities. In this manner, the ions can be guided into the space between the ion lens 302 and the ion deflector 304 and be deflected away from the initial propagation direction such that the ions are inhibited from entering the ions guide 2.

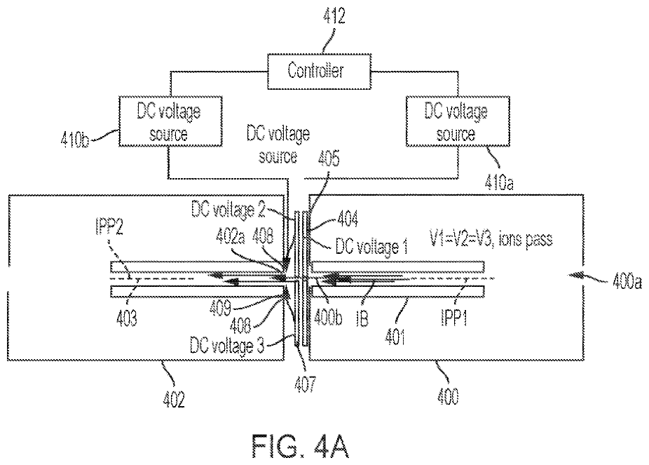

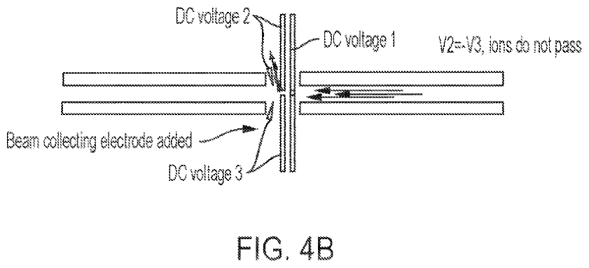

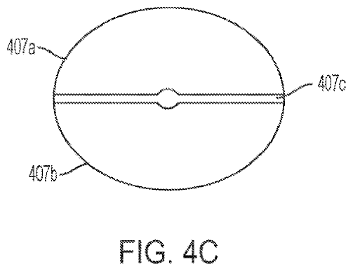

In some embodiments, the ion deflection assembly can include an ion collection electrode for collecting the ions deflected via passage through the ion deflection assembly. For example, FIGS. 4A and 4B schematically depict two differentially pumped chambers 400 and 402 that are positioned in tandem and are in fluid communication with one another. The chambers 400 and 402 are evacuated via one or more pumps so as to be maintained at a differential pressure relative to one another. The differentially pumped chambers 400 and 402 can be incorporated in a mass spectrometer. In this embodiment, the chambers 400 and 402 house, respectively, two rod sets 401 and 403, each of which includes four rods that are arranged in a quadrupole configuration, though other multipole configurations may be also employed. The rods of the rod sets are arranged so as to provide ion propagation paths IPP1 and IPP2 for ions passing through the rod sets.

One or more DC and/or RF voltage sources (not shown in the figure) can apply DC and/or RF voltages to the two rod sets such that they can provide their respective functions, e.g., as an ion guide and/or a mass analyzer. Although in this embodiment the chambers 400 and 402 house rod sets, in other embodiments other devices can be disposed in any of these chambers. In other words, the present teachings are not limited to modulating an ion beam that passes through multipole rod sets, but can be more generally applied for deflecting an ion beam along its propagation path.

The chamber 400 extends from an inlet 400a to an outlet 400b and chamber 402 extends from an inlet 402a to an outlet 402b. The outlet 400b of the chamber 400 is in fluid communication with the inlet 402a of the chamber 402 to allow the passage of ions from the chamber 400 into the chamber 402. In this embodiment, an ion deflector assembly 404 is positioned between the outlet 400b of the chamber 400 and the inlet 402a of the chamber 402. The ion deflector assembly 404 includes an ion lens 405 that can provide focusing of ions passing therethrough and an ion deflector 407 that can modulate the transfer of an ion beam from the chamber 400 into the chamber 402. An ion collection electrode 409 is positioned downstream of the ion deflector 407 to capture ions that are deflected by the ion deflector 407.

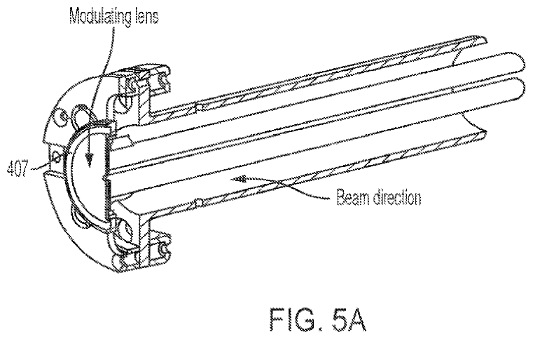

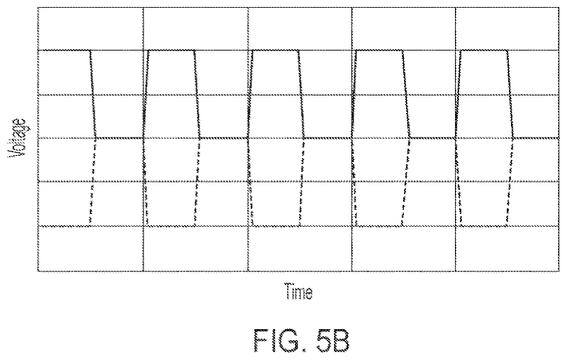

With particular reference to FIG. 4C as well as FIG. 5A, in this embodiment, the ion deflector 407 includes two conductive electrodes 407a and 407b that are electrically insulated from one another and are separated to form a slit 407c therebetween through which ions can pass. By way of example, as shown in FIG. 5A, an electrically insulating gasket can help maintain the two conductive electrodes of the ion deflector 407 between two chambers of the mass spectrometer while providing a vacuum seal between those chambers as well as electrical insulation between the conductive electrodes. A voltage differential applied between the ion lens 405 and the combination of the ion deflector 407 and the ion collection electrode 409 can be used to modulate the transfer of ions passing through the ion deflector 407.

Referring again to FIG. 4A, a voltage source 410a can apply a DC voltage 1 to the ion lens 405 and a DC voltage source 410b can apply a DC voltage 2 to the combination of the ion deflector 407 and the ion collection electrode 409. Although two separate voltage sources are depicted in this embodiment, the application of DC voltages to the ion lens 405 and the combination of the ion deflector 407 and the ion collection electrode 409 can be achieved via a single voltage source, e.g., a single voltage source having two DC power supplies.

A controller 412 in communication with the voltage sources 410a/410b can control those voltage sources so as to adjust voltage 1 and voltage 2. For example, the controller can cause the adjustment of voltages 1 and 2 so as to control the transmission of an ion beam IB from the chamber 401 into the chamber 402.

For example, as shown in FIG. 4A, the controller 410 can cause the voltage sources 410a/410b to apply the same DC voltages to the ion lens 405 and the combination of the ion deflector 407 and the ion collection electrode 409 (i.e., voltage 1=voltage 2). In this state, the ion beam IB passes undeflected through the ion deflector assembly 404 to reach the chamber 402.

In contrast, as shown in FIG. 4B, the controller 410 can send control signals to the voltage sources 410a and 410b to apply different voltages to the ion lens 405 and the combination of the ion deflector 407 and the ion collection electrode 409 so as to cause a deflection of the ion beam sufficient to substantially inhibit its passage into the chamber 402. An angle of deflection needed to substantially inhibit the passage of the ion beam into chamber 402 can vary depending on system-specific factors, such as geometric factors including, but not limited to, the axial separation between the outlet of the chamber 400 and the inlet of the chamber 402, among others. In general, in embodiments, the ion deflector assembly can be used to cause the deflection of an ion beam at a deflection angle in a range of about 5 to about 60 degrees, though other deflection angles may also be employed.

Further, rather than inhibiting the transfer of the ion beam between the two chambers, a voltage differential applied across the ion lens 405 and the combination of the ion deflector 407 and the ion collection electrode 409 can be adjusted so as to inhibit the passage of a portion of the ions into the chamber 402 while allowing other ions in the ion beam to reach the chamber 402 substantially undeflected, thereby modulating the intensity of the ion beam as it passes from chamber 400 into the chamber 402. By way of example, a deflection voltage differential across the ion lens 405 and the combination of the ion deflector 407 can be selected such that the deflection angle is small enough, e.g., an angle less than about 5 degrees, such as 1 degree, such that some of the ions are inhibited from passing into the chamber 402 while other ions in the beam continues to reach the downstream chamber 402.

FIG. 5B shows an example of modulating the transmission of ions between the chamber 400 and 402 using the ion deflector assembly 404 via periodically changing the voltage differential between the lens 405 and the combination of the ion deflector 407 and the ion collection electrode 409. In some embodiments, the modulation can be performed at a duty cycle, e.g., in a range of about 0.1 to about 1. In other embodiments, the ion deflector 407 can have other shapes.

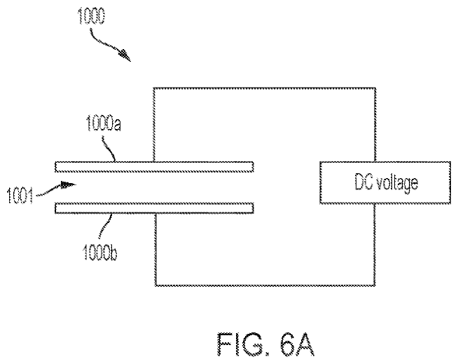

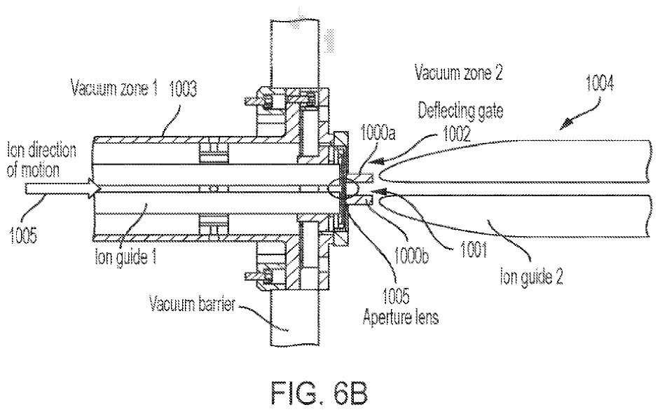

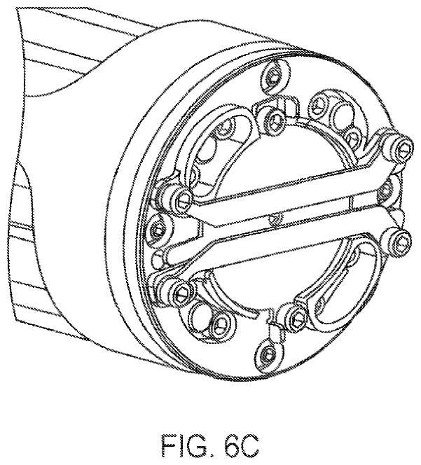

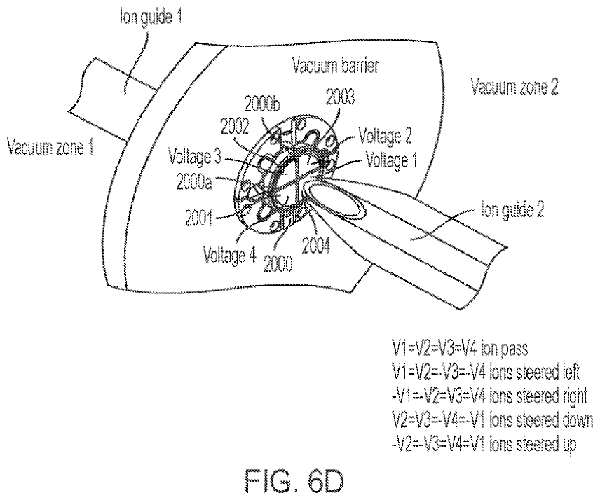

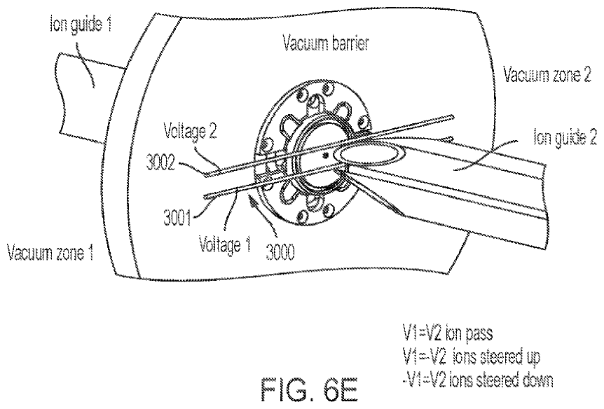

By way of example, FIG. 6A schematically depicts such an ion deflector 1000 that includes two plates 1000a/1000b that are separated from one another to provide a passageway 1001 therebetween through which ions can pass. The application of a DC voltage across these plates can generate an electric field that can cause the deflection of the ions as they pass through the passageway 1001.

In some embodiments, the length of the plates 1000a/1000b and the applied voltage can be selected so as to allow the deflected ions to leave the passageway and be optionally captured by an ion collection electrode, e.g., in a manner discussed above. In other embodiments, the length of the plates and the applied electric field can be selected such that the deflected ions (or at least a portion thereof) strike one of the plates and hence do not exit the ion deflector.

FIG. 6B is a partial schematic view of a mass spectrometer according to an embodiment of the present teachings in which a deflecting gate 1002 that incorporates the deflector 1000 discussed above is positioned between an upstream ion guide 1, which is disposed in a vacuum zone 1, and a downstream ion guide 2, which is disposed in a vacuum zone 2, to allow modulating the passage of an ion beam 1005 from the ion guide 1 into ion guide 2. In this embodiment, an aperture lens 1005 is positioned upstream of the ion deflecting plates 1000a/1000b of the ion deflector 1000. An opening 1005a provided in the ion lens 1005 can allow the passage of ions through the ion lens. As discussed herein, a voltage source operating under control of a controller (not shown in this figure) can modulate a DC voltage differential applied across the deflecting plates 1000a/1000b thereby modulating the passage of the ion beam from the ion guide 1 into the ion guide 2. For example, a DC voltage differential applied across the ion deflecting plates can deflect the ions so as to inhibit its passage into the ion guide 2 during certain temporal periods.

In some implementations, a periodic modulation of the DC voltage differential applied across the plates can result in a periodic modulation of the intensity of the ion beam passing between the ion guide 1 and the ion guide 2.

FIG. 6C schematically depict an ion deflector 2000 according to another embodiment of the present teachings, which includes two ion-deflecting plates 2000a and 2000b. This embodiment shows the end view where the deflecting plate(2000a and 2000b) are located adjacent to the aperture/lens (2001). When a potential difference is applied between the deflecting plates(2000a and 2000b), ions will not be transferred beyond this device. Having a common potential, the ions will be transferred to the next stage of the ion path.

FIG. 6D schematically depicts an ion deflector 2000 according to an embodiment according to the present teachings, which is positioned between two vacuum zones 1 and 2 (each of which can be in the form of a vacuum chamber), for changing the direction of propagation of an ion beam between two ion guides 1 and 2 positioned in the vacuum zones 1 and 2, respectively. The ion deflector 2000 includes four conductive electrodes 2001/2002/2003/2004 that are separated from one another so as to provide two orthogonal slits 2000a/2000b through which ions can pass. Each conductive electrode of the ion deflector is electrically insulated from the other conductive electrodes (e.g., via a dielectric gasket 2005 disposed in a groove surrounding the conductive electrodes). In this embodiment, the conductive electrodes have the same size and shape (they are wedge-shaped) and are positioned relative to one another such that their top surface are within a single plane and the ion deflector is symmetric with respect to 90-degree rotations about a putative axis passing through its center and being perpendicular to the aforementioned single plane.

The DC voltages applied to the conductive electrodes of the ion deflector 2000 can be adjusted, e.g., under control of a controller such as those disclosed herein, so as to deflect the ion beam in a desired direction (e.g., up, down, right or left) as the ions pass through the slits 2000a/2000b.

For example, when the voltages 1, 2, 3 and 4 applied to the conductive electrodes 2001/2002/2003/2004 of the ion deflector are equal, the ion beam will pass through the ion deflector without any deflection. Typically, the ion guide 2 is aligned relative to the ion deflector such that the ion beam will pass through the center of the ion beam deflector (i.e., the intersection of the two slits), when the voltages applied to the conductive electrodes of the ion deflector are equal. By way of example, in order to steer a positive ion beam propagating through the ion guide 1 towards ion guide 2 beam to the right, the magnitudes of the voltages applied to the conductive electrodes of the ion deflector can be the same with the voltages V1 and V2 having a positive polarity and the voltages V3 and V4 having a negative polarity.

In contrast, for steering the ion beam to the left, the voltages V1, V2, V3 and V4 can have the same magnitude with the voltages V3 and V4 having a positive polarity and the voltages V1 and V2 having a negative polarity. For steering the ion beam in an upward direction, the magnitudes of the voltages V1, V2, V3, and V4 can be the same with the voltages V2 and V3 having a positive polarity and the voltages V1 and V4 having a negative polarity and for steering the ion beam in a downward direction, the magnitudes of the voltages V1, V2, V3, and V4 can be the same with the voltages V1 and V4 having a positive polarity and the voltages V2 and V3 having a negative polarity.

The above ion deflector 2000 allows changing the direction of ion deflection from time to time. More specifically, the above ion deflector allows deflecting an ion beam along each of the following four directions: left, right, up and down. In some embodiments, by changing the direction of ion deflection from time to time, potential contamination caused by the deflected ions and their adverse effects may be minimized, and preferably eliminated. By way of example, a controller operably to the ion deflector 2000 can be programmed to modify the pattern of voltages applied to the four conductive electrodes of the ion deflector, e.g., based on a predefined temporal schedule, to change the deflection of the ion beam between the above four directions.

By way of further illustration, FIG. 6E schematically depicts an ion deflector 3000 that is positioned between the ion guide 1 and ion guide 2. Similar to the previous embodiment, the ion guides 1 and 2 are disposed in vacuum zones 1 and 2, which are typically maintained at different pressures. In this embodiment, the ion deflector 3000 includes two rods 3001/3002 that are separated and electrically insulated from one another to allow the application of independent voltages thereto. In this embodiment, an ion lens 3003 is positioned upstream of the ion deflector 3000 to facilitate the propagation of the ion beam from the ion guide 1 into the ion guide 2 via passage between the two rods 3001/3002 of the ion deflector 3000.

A voltage differential applied between the two rods 3001/3002 can be adjusted to modulate the propagation path of the ion beam. By way of example, when the voltages V1 and V2 applied to the rods 3001 and 3002, respectively, are equal (i.e., when the voltage differential between the two rods is zero), the ion beam passes through the ion deflector undeflected. For deflecting an ion beam with a positive polarity upward as the ion beam reaches the ion deflector via passage through the ion guide 1, the voltages V1 and V2 can have the same magnitudes with positive and negative polarities, respectively. In contrast, for deflecting the ion beam downward, the voltages V1 and V2 can have the same magnitudes with negative and positive polarities, respectively. It should be understood that other configurations of the voltages can also be utilized to achieve a desired deflection (steering) of the ion beam. For example, the applied voltages may have different magnitudes.

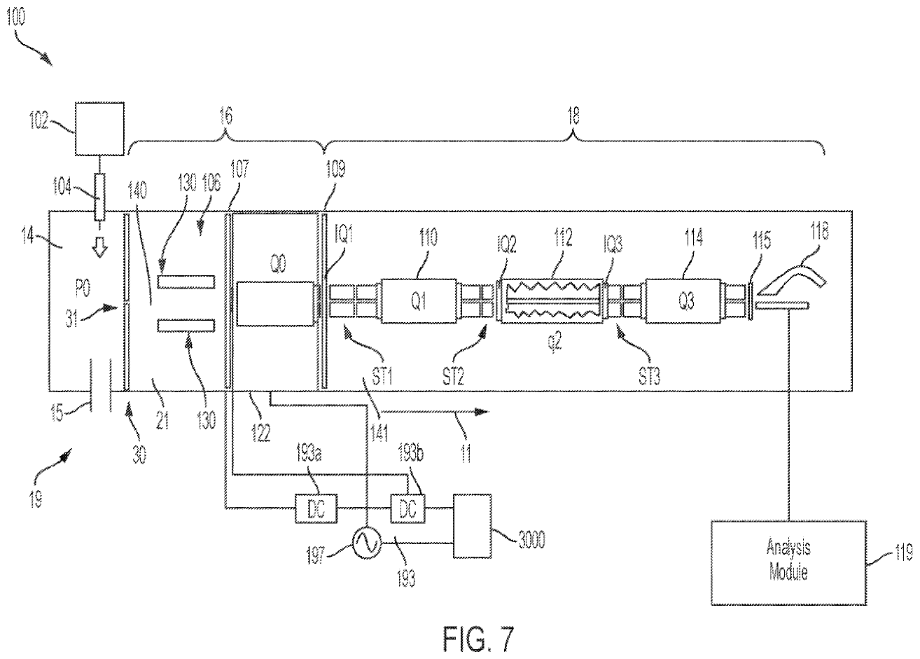

An ion deflector according to the present teachings can be incorporated in a variety of mass spectrometers. By way of example, with reference to FIG. 7, a mass spectrometer 100 according to an embodiment of the present teachings includes an ion source 104 that receives a sample from a sample source 102 and generates a plurality of ions that are introduced into an chamber 14, which is evacuated via a port 15.

At least a portion of the ions pass through an orifice 31 of an orifice plate 30 into a chamber 121 in which an ion guide 140 (herein also referred to as QJet® ion guide) is disposed.

The chamber 121 can be maintained, for example, at a pressure in a range of about 1 torr to about 3 torr. The QJet® ion guide includes four rods (two of which 130 are visible in the figure) that are arranged according to a quadrupole configuration to provide a passageway therebetween through which the ions can pass. RF voltages can be applied to the rods of the QJet® ion guide, e.g., via capacitive coupling to a downstream ion guide Q0 discussed further below or via an independent RF voltage source, for radially confining, and focusing the ions for transmission to a downstream chamber 122 in which an ion filter 108 according to an embodiment of the present teachings is disposed.

In this embodiment, an ion deflector assembly 107 such as that discussed above in connection with FIGS. 4A and 4B, which includes an ion lens, an ion deflector and an ion collection electrode, is positioned between the vacuum chamber 122 and the vacuum chamber 121 and helps modulate the transfer of ions between the vacuum chamber 121 and the vacuum chamber 122. In particular, as discussed above, a voltage differential applied between the ion deflector and the upstream lens can be used to allow or to inhibit the passage of ions from the vacuum chamber 121 into the vacuum chamber 122.

The chamber 122 can be maintained at a pressure lower than the pressure at which the chamber 121 is maintained. By way of example, the chamber 122 can be maintained at a pressure in a range of about 2 mTorr to about 15 mTorr. In this embodiment, an ion guide Q0 is positioned in the chamber 122. The ion guide Q0 includes a plurality of rods (not shown in the figure) that are arranged in a multipole configuration. An RF voltage source 197 applies RF voltages to the rods of the Q0 ion guide for providing radial confinement of the ions passing therethrough

In this embodiment, a DC voltage source 193a applies a DC voltage to the ion lens of the ion deflector assembly 107 (See, ion lens 405 discussed above) and a DC voltage source 193b applies a DC voltage to the combination of the ion deflector and the ion collection electrode of the ion deflector assembly (See, ion deflector 407 and ion collection electrode 409). In some embodiments, the DC voltage source can also be employed to apply DC voltages to the rods of the Q0 ion guide, e.g., to generate a voltage differential between the QJET and Q0 ion guides to accelerate the ions exiting the QJET ion guide towards the Q0 ion guide.

A controller 3000 controls the operation of the RF voltage source 197 as well as the DC voltage sources 193a and 193b. In particular, the controller can control the operation of the DC voltage sources 193a and 193b so as to modulate the transmission of ions between the evacuated chambers 121 and 122, e.g., in a manner discussed herein.

A mass analyzer Q1 110 receives the ions passing through the ion guide Q0 via an ion lens IQ1 and one stubby lens ST1. In this embodiment, the mass analyzer Q1 110 includes four rods that are arranged in a quadrupole configuration and to which RF and/or DC voltages can be applied for selecting ions having m/z ratios within a target range. The ions propagating through the mass analyzer Q1 110 (herein referred to as precursor ions) pass through stubby lenses ST2 and ion lens IQ2 to reach a collision cell 112 (q2).

At least a portion of the precursor ions are fragmented in the collision cell 112 to generate a plurality of product ions. The product ions pass through an ion lens IQ3 and a stubby lens ST3 to reach another downstream mass analyzer Q3. In this embodiment, the mass analyzer Q3 includes four rods that are arranged in a quadrupole configuration and to which RF and/or DC voltages can be applied to allow passage of product ions having an m/z ratio of interest. The product ions passing through the mass analyzer Q3 pass through an exit lens 115 to be detected by an ion detector 118. In some embodiments, the quadrupole mass analyzer Q3 can be replaced with a time-of-flight (ToF) mass analyzer or any other suitable mass analyzer. An analysis module 119 can receive the detection signals generated by the ion detector 118 and process those signals to generate a mass spectrum of the detected ions.

A controller 3000 in communication with the voltage sources 193a and 193b can control these voltage sources to adjust the voltages applied to the ion lens and the combination of the ion deflector and the ion collection electrode to modulate the passage of an ion beam between the QJET and Q0 ion guides, in a manner discussed above. The controller 3000 can also control the operation of the RF voltage source. In addition, in embodiments in which the voltage source 193a and/or 193b are used to apply DC voltages to the rods of the ion guides and/or mass analyzers of the mass spectrometer, the controller 3000 can also control the voltage sources so as to adjust the voltages applied to those devices.

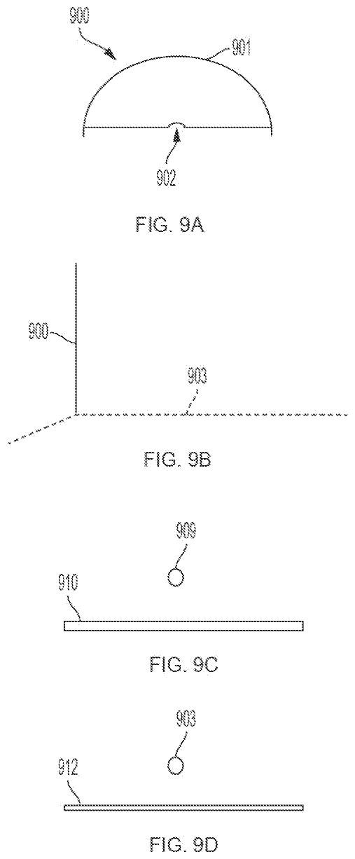

With reference to FIGS. 9A and 9B, in some embodiments, an ion deflector 900 can be utilized, which includes a single electrically conductive electrode 901, e.g., a metal electrode such as those disclosed above, having a cut-out 902 through which an ion beam 903 can pass. As discussed in more detail below, the single electrically conductive electrode 901 can be positioned downstream of an ion lens and a voltage applied to the single electrically conductive electrode 901, e.g., via a DC voltage source operating under control of a controller, can be adjusted so as to allow an ion beam to pass through undeflected or to cause the deflection of the ion beam. The electrically conductive electrode 901 can be positioned below or above the ion beam and can be biased via the application of the DC voltage thereto to cause the deflection of the ion beam away from the electrode, e.g., in an upward or a downward direction.

The conductive electrode 901 can be biased via application of a DC bias voltage thereto to repel the ions in the beam as they pass through, thereby deflecting the ion beam away from the electrode, as shown schematically in FIG. 9B. One advantage of such an embodiment is that it reduces, and preferably eliminates, the contamination of the ion deflecting electrode by the deflected ions. In other words, in this embodiment, rather than utilizing both a “push” and a “pull” electrode for causing the deflection of an ion beam, only a “push” electrode is utilized. This can eliminate the potential contamination of the “pull” electrode via ion impact.

By way of example, the embodiment depicted in FIG. 4A can be modified to replace the ion deflector 407 having conductive electrodes 407a and 407b as depicted in FIG. 4C with only one of those conductive electrodes, e.g., the conductive electrode 407a or the conductive electrode 407b, e.g., as schematically depicted in FIGS. 9A and 9B. In such a modified embodiment, the DC voltage source, e.g., the DC voltage source 410a, operating under control of the controller 412 can adjust a bias DC voltage applied to the conductive electrode 901. For example, to allow an ion beam to pass undeflected over or below the conductive electrode, the conductive electrode can be maintained at the same DC voltage as the upstream ion lens 405. The DC bias voltage can be changed to cause a deflection of the ion beam away from the conductive electrode when the ion beam deflection is desired.

With reference to FIGS. 9C and 9D, in some embodiments, the single electrically conductive electrode can be in the form of an electrically conductive bar 910 or an electrically conductive wire 912. The application of a DC bias voltage to the conductive bar 910 or the conductive wire 912, in a manner discussed herein, can cause deflection of the ion beam 903 passing over or below the conductive bar or the wire. By way of example, the electrically conductive bar 910 can have a square cross-sectional profile with a length in a range of about 1 mm to about 50 mm and a width/thickness in a range of about 0.1 mm to about 10 mm. In some embodiments, the conductive wire 912 can have a diameter of about 0.5 mm, by way of example. Other shapes can also be utilized so long as the conductive electrode is capable of causing the deflection of an ion beam via application of a DC bias voltage to the electrode.

The controller 3000 can be implemented in hardware, firmware and/or software using known techniques in the art as informed by the present teachings.

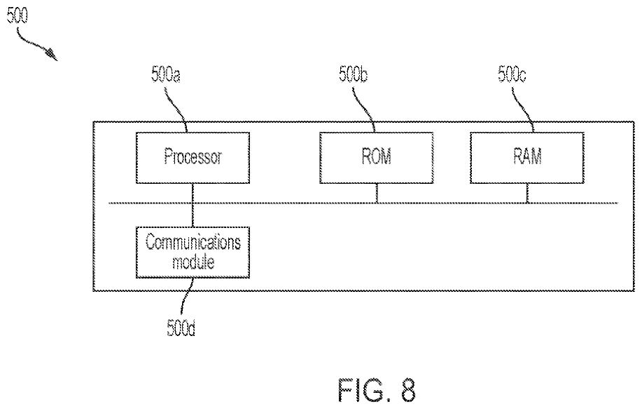

By way of example, FIG. 8 schematically depicts an example of an implementation of such a controller 500, which includes a processor 500a (e.g., a microprocessor), at least one permanent memory module 500b (e.g., ROM), at least one transient memory module (e.g., RAM) 500c, and a bus 500d, among other elements generally known in the art.

The bus 500d allows communication between the processor and various other components of the controller. In this example, the controller 500 can further include a communications module 500e that is configured to allow sending and receiving signals.

Instructions for use by the controller 500, e.g., for adjusting the DC voltages applied to the auxiliary electrodes, can be stored in the permanent memory module 500b and can be transferred into the transient memory module 500c during runtime for execution. The controller 500 can also be configured to control the operation of other components of the mass spectrometer, such as the ion guide, and mass analyzer, among others.

The present teachings can provide advantages relative to conventional techniques for adjusting an intensity of the ion beam. For example, the modulation of an ion beam using the present teachings can provide a more homogeneous ion beam than conventional pulsing techniques employed for reducing the intensity of an ion beam, e.g., as it passes from one ion chamber into an downstream chamber while reducing, and preferably eliminating, contamination of ion optics positioned between the two chambers.

Those having ordinary skill will appreciate that various changes can be made to the above embodiments without departing from the scope of the present teachings.

What is claimed is:

1. A mass spectrometer, comprising:
an ion path along which an ion beam can propagate,
an ion beam deflector positioned in said ion path and configured to modulate transfer of an ion beam received from an upstream section of the ion path to a downstream section thereof, said ion beam deflector comprising at least one electrically conductive electrode,
at least one DC voltage source operably coupled to said at least one electrically conductive electrode for application of DC voltages thereto, and
a controller in communication with said at least one DC voltage source for modulating DC voltages applied to said at least one electrically conductive electrode so as to transition the DC voltage applied to said at least one electrode between a first level at which the ion beam passes substantially undeflected through said ion beam deflector and a second level at which the ion beam is deflected from said ion path.

2. The mass spectrometer of claim 1, further comprising at least one beam-collecting electrode disposed downstream of said ion beam deflector for collecting said deflected ion beam.

3. The mass spectrometer of claim 1, further comprising at least one evacuated chamber in which at least a portion of said ion path is disposed.

4. The mass spectrometer of claim 3, wherein said at least one evacuated chamber comprises a first evacuated chamber and a second evacuated chamber positioned downstream of said first evacuated chamber, wherein said first and second evacuated chambers are differentially pumped so as to be maintained at different pressures.

5. The mass spectrometer of claim 4, wherein said ion beam deflector is positioned between said two evacuated chambers.

6. The mass spectrometer of claim 1, further comprising an ion lens disposed upstream of said ion beam deflector.

7. The mass spectrometer of claim 6, wherein said ion lens comprises an opening through which the ion beam can pass.

8. The mass spectrometer of claim 6, wherein said controller is configured to cause said at least one DC voltage source to adjust a DC voltage applied to said at least one electrically conductive electrode between a first level at which the at least one electrically conductive electrode and the ion lens are maintained at the same electric potential to allow the ion beam to pass undeflected through the ion beam deflector and a second level at which the at least one electrically conductive electrode and the ion lens are maintained at different electric potentials to cause the ion beam to deflect as the ion beam passes through the ion beam deflector.

9. The mass spectrometer of claim 8, wherein the DC potential at the second level is selected to cause a deflection of the ion beam relative to said ion path at an angle in a range of about 5 degrees to about 60 degrees.

10. The mass spectrometer of claim 1, wherein said at least one electrically conductive electrode includes at least two electrically conductive electrodes positioned relative to one another to provide an opening through which the ion beam can pass, and wherein optionally said two electrically conductive electrodes comprise two conductive electrodes of an ion lens that are separated from one another to form a gap therebetween through which the ion beam can pass.

11. The mass spectrometer of claim 10, wherein said controller is configured to cause said at least one DC voltage source to apply substantially similar DC voltages to said two electrodes so as to allow the ion beam to pass substantially undeflected through said ion beam deflector.

12. The mass spectrometer of claim 10, wherein said controller is configured to cause said at least one DC voltage source to apply a DC potential difference between said two electrodes so as to cause deflection of the ion beam relative to said ion path at an angle in a range of about 5 degrees to about 60 degrees.

13. The mass spectrometer of claim 4, wherein the first chamber is maintained at a pressure in a range of 0.1 Torr to about 10 Torr.

14. The mass spectrometer of claim 4, wherein the second chamber is maintained at a pressure in a range of about 0.001 Torr to about 0.1 Torr.

15. The mass spectrometer of claim 1, wherein said controller is configured to modulate the voltages applied to said ion beam deflector so as to modulate passage of the ion beam through the ion beam deflector at a duty cycle in a range of about 0.1 to about 1.

16. The mass spectrometer of claim 4, wherein said second level of the DC voltage is configured to deflect the ion beam so as to substantially inhibit passage of the ion beam into said second evacuated chamber.

17. The mass spectrometer of claim 1, wherein said at least one electrically conductive electrode has a hemispherical shape, and wherein said at least one electrically conductive electrode comprises an electrically conductive plate.

18. The mass spectrometer of claim 3, further comprising an ion guide disposed in said evacuated chamber.

19. The mass spectrometer of claim 18, wherein said ion guide comprises a plurality of rods disposed in said evacuated chamber, wherein said rods are arranged in a multipole configuration providing a passageway for transit of the ion beam therethrough.

20. The mass spectrometer of claim 19, further comprising an RF voltage source for application of RF voltages to said rods for generating an electromagnetic field configured for radial confinement of ions in said ion beam as the ions pass through said passageway.
